(19) United States
(12) Patent Application Publication
(10) Pub. No.: US 2013/0077290 A1
(43) Pub. Date: Mar. 28, 2013

(54) Brake Light System for a Helmet

(71) Applicant: Leslie K. HuiHui, Henderson, NV (US)

(72) Inventor: Leslie K. HuiHui, Henderson, NV (US)

(21) Appl. No.: 13/245,834

(22) Filed: Sep. 26, 2011

(51) Int. Cl. F21V 21/084

(52) U.S. Cl. 362/106

(57) ABSTRACT

A system comprises a brake light housing comprising a flat front surface and a concave rear surface being configured to conform to a shape of a helmet. A flexible base member is joined to the rear surface. The flexible base member is configured to form a seal with the helmet to mitigate wind from dislodging the brake light housing from the helmet. A light source is disposed within the brake light housing to emit an illumination toward the front surface. A receiver is disposed within the brake light housing to receive a signal indicating an application of a brake of a vehicle and to active the light source for a duration of the signal. A transmitter is configured to be joinable to the vehicle, to be in communication with the vehicle's braking system, and to communicate the signal to the receiver for a duration of the application of the brake.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to vehicle accessories. More particularly, the invention relates to a supplemental brake light.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Motorcycles, mopeds and scooters typically comprise a single brake light on the rear, which usually sits about two and a half feet off the ground. This is not exactly within the eyesight of following drivers, which means that the visibility of a motorcycle or scooter brake light is often less than optimal.

By way of educational background, an aspect of the prior art generally useful to be aware of is that additional vehicle lighting can be purchased aftermarket for application near the existing brake light. Furthermore, there is some lighting currently available for application upon a helmet.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary brake light for a supplemental brake light system, in accordance with an embodiment of the present invention. FIG. 1A is a front perspective view. FIG. 1B is a side perspective view. FIG. 1C is a front perspective view of the brake light in an open position, and FIG. 1D is a side perspective view of the brake light being mounted to a helmet; and

FIGS. 2A through 2C illustrate an exemplary RF transmitter for a supplemental brake light system, in accordance with an embodiment of the present invention. FIG. 2A is a side perspective view. FIG. 2B is a transparent side perspective view, and FIG. 2C is a side perspective view of the transmitter mounted to a motorcycle brake light.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A practical embodiment of the present invention offers secondary lighting for the provision of improved visibility and safety of motorcycles and motorcycle riders. Many practical embodiments provide a brake light that can be applied upon the rear of a helmet, which can improve the visibility and safety of motorcycles and their users with the provision of secondary brake lighting that is positioned at a higher level than standard motorcycle brake lights. Many practical embodiments may be implemented for use on various different small vehicles including, without limitation, motorcycles, mopeds, scooters, ATVs, etc. Moreover, many practical embodiments project more lighting, are easier to apply, are easier to maintain, and are more durable than are other items with similar intentions. Currently available aftermarket secondary vehicle lighting is typically made for application in the same low and hard-to-see location as the existing brake light of a motorcycle. There is some lighting currently available for application upon a helmet. However this lighting usually broadcasts at a very weak level, meaning that it is generally ineffective at providing the lighting needed to garner other drivers' attention. Also this currently available lighting often lacks adequate battery power, meaning it does not provide the needed lighting for extended periods of time. Furthermore, these means typically apply to helmets by insecure means, meaning they may easily detach from the helmet.

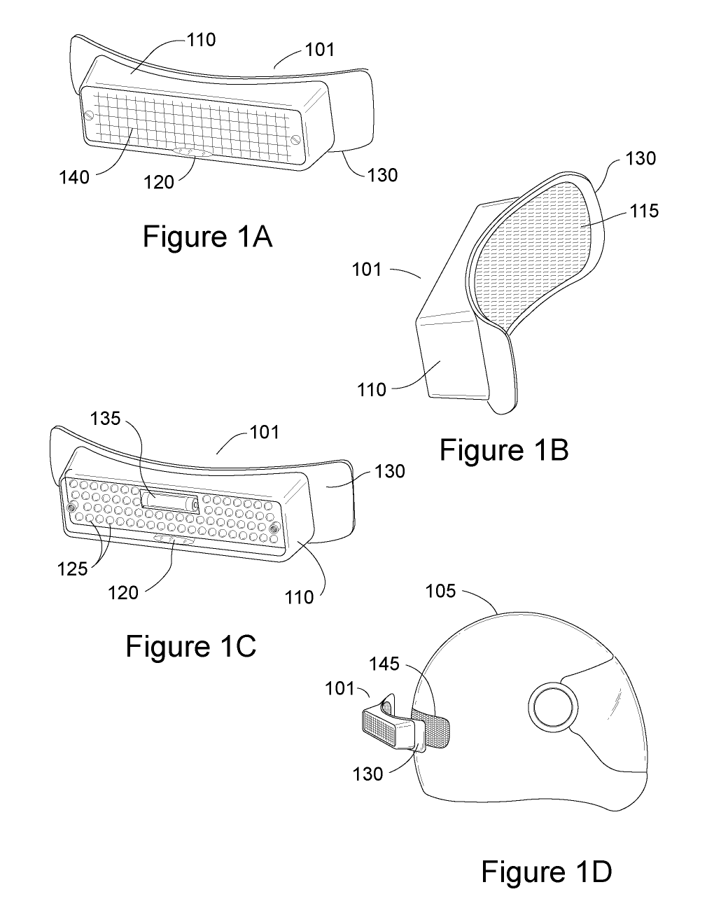

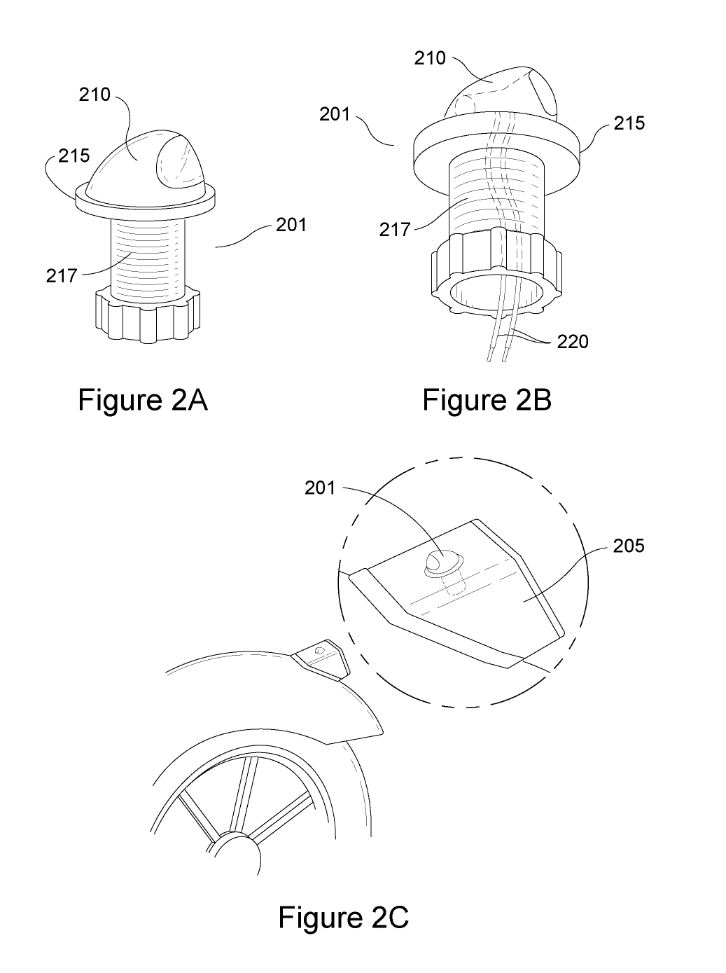

FIGS. 1A through 1D illustrate an exemplary brake light 101 for a supplementary brake light system, in accordance with an embodiment of the present invention. FIG. 1A is a front perspective view. FIG. 1B is a side perspective view. FIG. 1C is a front perspective view of brake light 101 in an open position, and FIG. 1D is a side perspective view of brake light 101 being mounted to a helmet 105. In the present embodiment, brake light 101 comprises a lighting piece 110, hook-and-loop material 115 for the application of brake light 101 upon helmet 105, and a radio frequency (RF) receiver 120 for the activation of brake light 101. Receiver 120 communicates directly with an RF transmitter that is mounted upon a vehicle and connects to the electrical system of the vehicle by wiring, as illustrated by way of example in FIGS. 2A through 2C. Lighting piece 110 comprises light-emitting diode (LED) lighting 125 and is rectangular in shape in a convex format of approximately seven inches in length by four inches in height (7″×4″). It is contemplated that the lighting pieces in some alternate embodiments can be made in various different sizes and in a multiplicity of suitable shapes such as, but not limited to, circular shapes, ovals, squares, etc. Moreover, the lighting pieces in some alternate embodiments may comprise various different types of lighting such as but not limited to incandescent lighting. In the present embodiment, lighting piece 110 is hosted upon a flexible base 130 made of plasticized polyvinyl chloride (PVC). In some alternate embodiments the base may be made of various different flexible yet durable materials, including but not limited to woven nylon fabric, rubber elastomer, polypropylene (PP), or a combination of these and other materials. In the present embodiment, base 130 is larger than lighting piece 110. Lighting piece 110 can be made of various different materials such as but not limited to polypropylene (PP), plasticized polyvinyl chloride (PVC), various metals, metal alloys, etc.

In the present embodiment, RF receiver 120 is located on lighting piece 110 and is connected by wiring to LED lighting 125. RF receiver 120 is set for a specific megahertz (MHz) signal. Referring to FIG. 1C, a battery 135 is also included within lighting piece 110 for the powering of receiver 120 and LED lighting 125. A AAA battery 135 is shown by way of example; however, various different types and sizes of batteries may be used in lighting pieces in alternate embodiments. Brake light 101 automatically activates upon insertion of battery 135; however, some alternate embodiments may comprise a manual power switch upon the lighting piece to activate brake light 101. Referring to FIG. 1A, a faceplate 140 made of pliant plasticized PVC in a translucent red color covers LED lighting 125 and battery 135. In some alternate embodiments various different materials may be used for the faceplate including, without limitation, different plastics, glass, resin, etc. In the present embodiment, to access battery 135 a user can simply remove faceplate 140 from lighting piece 110. Faceplate 140 may be attached to lighting piece 110 using a multiplicity of suitable means including, but not limited to, screws, bolts, snapping into place, clips, etc. The user does not need to remove brake light 101 from helmet 105 to access battery 135.

Referring to FIG. 1B, hook and loop material 115 is located on the rear wall of lighting piece 110 opposite faceplate 140. Referring to FIG. 1D, a corresponding swatch of hook and loop material 145 is included, without limitation, for application directly upon helmet 105 by use of polymer dispersion adhesive in polyvinyl acetate (PVA) format. In some alternate embodiments, the adhesive used to apply the hook-and-loop material upon the helmet can be of various solvent based or polymer dispersion varieties. In some embodiments, the system may also include, without limitation, a template to generally ensure proper placement of the brake light unit upon the helmet. In the present embodiment, to attach brake light 101 to helmet 105, a user aligns hook and loop material 115 on the backside of brake light 101 with hook and loop material 145 on helmet 105. Flexible base 130 conforms to the shape of helmet 105 and progressively thins towards the outer edges to generally ensure a tight fit upon helmet 105. The left and right edges of base 130 typically make contact with helmet 105 before the two sections of hook and loop material meet. Therefore, the user must firmly press brake light 101 towards helmet 105, which typically causes base 130 to spread along helmet 105 and enables the two sections of hook and loop material to meet. This spreading of the edges of base 130 along helmet 105, in conjunction with the thin edges of the base 130, causes an almost air tight seal. Wind blowing around helmet 105 typically blows over the thin, smooth edges of base 130 and generally does not get under and pry up the edges. Therefore, wind generally cannot dislodge brake light 101 from helmet 105. This is particularly important at high speeds such as, but not limited to, highway speed. In some alternate embodiments, the brake light may be attached to a helmet using various different means such as, but not limited to, adhesive, screws, brackets, magnets, snaps, etc. In the present embodiment, brake light 101 can be removed from helmet 105 and re-applied as often as desired with little risk of damage to brake light 101 or helmet 105. For example, without limitation, the user may wish to remove brake light 101 from helmet 105 when he has a passenger on his motorcycle. In addition, if the user does have a passenger, the user can use a separate piece of hook and loop material to secure brake light 101 to the passenger's helmet.

FIGS. 2A through 2C illustrate an exemplary RF transmitter 201 for a supplementary brake light system, in accordance with an embodiment of the present invention. FIG. 2A is a side perspective view of RF transmitter 201. FIG. 2B is a transparent side perspective view of transmitter 201, and FIG. 2C is a side perspective view of transmitter 201 mounted to a motorcycle brake light 205. In the present embodiment, RF transmitter 201 broadcasts in the same range of two-to-ten megahertz (2-10 MHz) as a corresponding receiver on a helmet-mounted brake light, as shown by way of example in FIGS. 1A and 1C. Transmitter 201 comprises a raised node 210 that projects from a plate 215 at an approximate thirty-degree (30°) angle and a threaded stem 217. Transmitter 201 is made of durable polyvinyl chloride (PVC) material. It is contemplated that in some alternate embodiments, the transmitter can be made of various different materials, such as but not limited to Plexiglas™, fiberglass, sheet metal, acrylonitrile butadiene styrene (ABS), etc. Furthermore, the transmitters in some alternate embodiments can be made in various different sizes and shapes to accommodate application upon a motorcycle or scooter in a multiplicity of strategic locations. Referring to FIG. 2B, in the present embodiment, wiring 220 extends from node 210 for application to the electrical wiring of the brakes of the hosting vehicle. RF transmitter 201 generally ensures proper communication with a corresponding brake light-activating receiver and is typically not subject to interference from other signals. RF transmitter 201 broadcasts at an individual frequency that generally does not activate other receivers, and the corresponding receiver is generally not activated by other transmitters. It is contemplated that in alternate embodiments various different types of signals may be used to activate the brake light such as, but not limited to, infrared signals, microwave signals, visible light, audio signals, etc. Other alternate embodiments may be implemented without a transmitter or receiver in which an electric coil cord of an accommodating length links the vehicle's electrical system and the helmet lighting.

In the present embodiment, RF transmitter 201 may be attached upon brake light 205 near the rear fender area of a hosting motorcycle by screwing threaded stem 217 into brake light 205. Then wiring 220 of transmitter 201 can be attached to the electrical wiring of the motorcycle. The transmitter is positioned so that the angle of projecting node 210 aims toward the seat of the motorcycle. Those skilled in the art, in light of the teachings of the present invention, will readily recognize that a multiplicity of suitable means may be used in some alternate embodiments to attach the transmitter to a vehicle such as, but not limited to, adhesives, welding, brackets, magnets, etc.

In typical use of the present embodiment, once transmitter 201 is attached to a vehicle and brake light 101 is attached to helmet 105 with battery 135 in place, the user can place helmet 105 on his head. Each time the user applies the brakes of the vehicle transmitter 201 receives this information through wiring 220 and sends a signal to receiver 120. This activates brake light 101. Brake light 101 can be activated exclusively by a front brake operation, a rear brake operation or by the operation of either front or rear brake. Brake light 101 is bright and features full illumination of the brake light area. With this additional, raised and sizable brake light 101, it is believed that vehicles behind the user are more likely to be adequately forewarned of the presence of the user and his braking.

The supplementary brake light system according to the present embodiment provides additional brake lighting for motorcycle, scooter and moped riders in a strategic location upon the rear of a user's helmet. This location is at a higher point than the standard rear brake light of typical motorcycles, scooters and mopeds and is more in line with the eyesight range of automobile drivers. This is believed to makes motorcycle, scooter and moped riders more visible to other vehicles and to improve the safety of users. Since motorcycles decelerate faster than automobiles do, which can supplemental motorcycles at risk of being struck from behind due to such deceleration, the improved brake lighting offered by the present embodiment can help dissuade such incidents by generally ensuring more visibility and faster response to motorcycle brakeage. The present embodiment is particularly useful when used at night and in otherwise poorly lit environments. The present embodiment may also encourage compliance with laws pertaining to helmet usage. Furthermore, by improving the safety of users and reducing their risks, the present embodiment can help reduce the costs of vehicle insurance.

Unlike some current secondary lighting for motorcycles, the present embodiment offers secure placement upon helmets and is typically not subject to easily fall off of helmets upon which it is placed. Unlike some current secondary lighting for motorcycles, the present embodiment allows the brake light unit to be easily removed and replaced upon the hosting helmet at the user's discretion. Unlike some current secondary lighting for motorcycles, the present embodiment broadcasts bright and easily visible lighting, which provides better safety than less visible secondary lighting for motorcycle. Battery 135 that powers lighting 125 is more easily accessible than some current secondary lighting for motorcycles, which makes this system easier to maintain and able to broadcast brighter light with more consistency. Unlike some current secondary lighting for motorcycles, which automatically begin to blink after a short period due to need to reserve their batteries, the present embodiment can continuously broadcast its lighting without blinking, which is more noticeable and more effective at communicating the message of braking without misinterpretation by viewers.

Some alternate embodiments of the present invention can be made in variations that comprise lighting and a signal receiver built within a helmet and a separate transmitter unit for application upon a vehicle. Other alternate embodiments can be made in variations that comprise a transmitter unit built within a vehicle and separate lighting for application upon a helmet. Yet other alternate embodiments can be made in variations that comprise all portions built within their applicable hosts.

Those skilled in the art, in light of the teachings of the present invention, will readily recognize that some alternate embodiments may be implemented with various different and additional features such as, but not limited to, lighting pieces for turn signals, lights of various different colors, different lighting modes including without limitation flashing or scrolling, speakers for producing audio alerts, etc. Some alternate embodiments can be made in variations in which the lighting is activated by motion sensor should an extended deceleration be detected to improve the potential braking response time of following vehicles. Some alternate embodiments may be implemented for use with bicycles.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing supplemental brake lighting according to the present invention will be apparent to those skilled in the art. The invention has been described above by way of illustration, and the specific embodiments disclosed are not intended to limit the invention to the particular forms disclosed. For example, the particular implementation of the base of the light may vary depending upon the particular type of item on which it is to be used. The lights described in the foregoing were directed to helmet-mounted implementations; however, similar techniques are to provide brake lights that may be mounted in various different locations including, without limitation, jackets or seatbacks. Non-helmet-mounted implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
a brake light housing comprising a flat front surface and a concave rear surface, said concave rear surface being configured to conform to a convex shape of a helmet;
a flexible base member being joined to said concave rear surface, said flexible base member comprising dimensions to extend beyond a perimeter of said concave rear surface, said flexible base member being configured to form a seal with the helmet to mitigate wind from dislodging said brake light housing from the helmet;
a light source being disposed within said brake light housing and being configured to emit an illumination toward said flat front surface;
a receiver being disposed within said brake light housing, said receiver being configured to receive a signal indicating an application of a brake of a vehicle being driven by a user wearing the helmet and to active said light source for a duration of said signal; and
a transmitter being configured to be joinable to the vehicle, to be in communication with the vehicle's braking system, and to communicate said signal to said receiver for a duration of the application of the brake.

2. The system as recited in claim 1, further comprising a translucent faceplate being removably joined to said flat front surface.

3. The system as recited in claim 2, in which said translucent faceplate comprises a red color.

4. The system as recited in claim 2, further comprising screws for removably joining said faceplate to said front surface.

5. The system as recited in claim 2, further comprising a power source disposed within said brake light housing for powering said light source and said receiver.

6. The system as recited in claim 5, in which said power source comprises a battery being configured for replacement by removal of said faceplate.

7. The system as recited in claim 1, further comprising a joining system being configured to removably join said flexible base member to the helmet after said flexible base member forms the seal.

8. The system as recited in claim 7, in which said joining system comprises a swatch of hook and loop material joined to the helmet and hook and loop material joined to said flexible base member.

9. The system as recited in claim 1, in which said transmitter comprises a screw member for joining to the vehicle's brake light.

10. The system as recited in claim 1, in which said transmitter communicates with the vehicle's braking system by connection to the vehicle's brake light wiring.

11. The system as recited in claim 1, in which said transmitter communicates said signal using a radio frequency transmission.

12. The system as recited in claim 11, in which said transmitter further comprises a node for directing the radio frequency transmission to the receiver.

13. The system as recited in claim 1, in which said light source comprises Light Emitting Diodes.

14. The system as recited in claim 1, in which said brake light housing further comprises a rectangular shape.

15. A system comprising:
a brake light housing for conforming to a convex shape of a helmet;
means for sealing said brake light housing with the helmet to mitigate wind from dislodging said brake light housing from the helmet;
means for removably joining said brake light housing and said sealing means to the helmet after said sealing means forms the seal;
means for emitting an illumination;
means for passing the illumination out of said brake light housing;
means for receiving a signal indicating an application of a brake and for activating said emitting means for a duration of said signal;
means for powering said emitting means and said receiving and activating means; and
means for transmitting said signal to said receiving and activating means for a duration of the application of the brake.

16. A system comprising:
a brake light housing comprising a flat front surface and a concave rear surface, said concave rear surface being configured to conform to a convex shape of a helmet;
a flexible base member being joined to said concave rear surface, said flexible base member comprising dimensions to extend beyond a perimeter of said concave rear surface, said flexible base member being configured to form a seal with the helmet to mitigate wind from dislodging said brake light housing from the helmet;
a joining system being configured to removably join said flexible base member to the helmet after said flexible base member forms the seal;
a light source being disposed within said brake light housing and being configured to emit an illumination toward said flat front surface, said light source comprising Light Emitting Diodes;
a translucent faceplate being removably joined to said flat front surface for passing the illumination out of said brake light housing, said translucent faceplate comprising a red color;
a receiver being disposed within said brake light housing, said receiver being configured to receive a radio frequency signal indicating an application of a brake of a vehicle being driven by a user wearing the helmet and to active said light source for a duration of said radio frequency signal;
a battery being disposed within said brake light housing for powering said light source and said receiver, said battery being configured for replacement by removal of said faceplate; and
a transmitter being configured to be joinable to the vehicle, to be in communication with the vehicle's brake light wiring, and to communicate said radio frequency signal to said receiver for a duration of the application of the brake.

17. The system as recited in claim 16, further comprising screws for removably joining said faceplate to said front surface.

18. The system as recited in claim 16, in which said joining system comprises a swatch of hook and loop material joined to the helmet and hook and loop material joined to said flexible base member.

19. The system as recited in claim 16, in which said transmitter further comprises a node for directing the transmission to the receiver.

20. The system as recited in claim 16, in which said brake light housing further comprises a rectangular shape.
